(19) United States
(12) Patent Application Publication
(10) Pub. No.: US 2011/0080321 A1
(43) Pub. Date: Apr. 7, 2011

(54) Signal processing techniques for improving the sensitivity of GPS receivers

(75) Inventors: Farrokh Farrokhi, San Ramon, CA (US); Dickson T. Wong, Burlingame, CA (US); Arthur J. Collmeyer, Incline Village, NV (US)

(73) Assignee: etherwhere Corporation

(21) Appl. No.: 12/587,100

(22) Filed: Oct. 2, 2009

(51) Int. Cl. G01S 19/24

(52) U.S. Cl. 342/357.63

(57) ABSTRACT

The use of multiple GPS sensors provides the conceptual framework for novel techniques for reducing the minimum signal strength required by a GPS assistance system to acquire and accurately track GPS satellites at or near the horizon. A strong signal attenuation system for synthesizing GPS satellite-specific I/F signals, enabling more efficient and effective acquisition of GPS satellites, is disclosed, comprising N+1 reference GPS sensors, each with an omni-directional antenna and front end, for down converting composite GPS satellite signals, and strong signal suppression (SSS) means for synthesizing, from the I/F signals produced by the N+1 reference GPS sensors, a set of one or more I/F signals (corresponding to a set of designated satellites), each with at least N of the strongest potentially-interfering satellite signals suppressed.

### CROSS-REFERENCE TO RELATED APPLICATIONS

This application claims priority under 35 U.S.C. ξ 120 from co-pending U.S. Patent Applications entitled “Signal Processing Techniques for Improving the Receive Sensitivity of GPS Receivers”, filed contemporaneously.

### STATEMENT REGARDING FEDERALLY SPONSORED RESEARCH OR DEVELOPMENT

Not Applicable

### BACKGROUND OF THE INVENTION

This invention relates to the determination of location coordinates of devices embodying GPS sensors.

The NAVSTAR Global Positioning System (GPS) developed by the United States Department of Defense uses a constellation of between 24 and 32 Medium Earth Orbit satellites that transmit precise microwave signals, which allows devices embodying GPS sensors to determine their current location. The initial application was predominantly for military purposes, namely weapons targeting and troop deployment. The first widespread consumer based application was navigational assistance. These early applications shared similar operating conditions in that the GPS navigational devices (also called GPS receivers) were (1) used outdoors, and (2) co-located with the end-user. Because of the requirement for mobility, GPS receivers were typically battery-operated devices, with power consumption a critical design consideration.

Today, a new wave of applications is emerging, requiring a wider operating environment, including indoor operation. The major sectors include, government and safety—(emergency location and E-911 services), enterprise and industrial (asset tracking and monitoring), and consumer (location based services). Because current GPS processing techniques are unable to provide the receive sensitivity required for reliable indoor operation, these applications have developed slowly. The major factors impacting indoor and “urban canyon” operation of GPS receivers are (1) path losses due to obstructions between the GPS satellites and the GPS receiver, (2) multi-path fading of the incoming GPS signal, and (3) the requirement to obtain pseudo ranges for a minimum of four GPS satellites in order to determine the three dimensional coordinates of the GPS receiver.

The signals from all the GPS satellites are broadcast using the same carrier frequency, 1.57 GHz in the case of the NAVSTAR system. However, each satellite has a unique identifier, or pseudorandom noise (PRN) code having 1023 chips, thereby enabling a GPS receiver to distinguish the GPS signal from one GPS satellite from the GPS signal from another GPS satellite. In addition, each satellite transmits information allowing the GPS receiver to determine the exact location of the satellite at a given time. The GPS receiver determines the distance (pseudo range) from each GPS satellite by determining the time delay of the received signal. The pseudo range information includes a local time offset to each GPS satellite from the time-of-arrival of the PRN code, the Zcount and ephemeris parameters in the GPS signal that it receives from that GPS satellite. The determination of three-dimensional location coordinates can be accomplished with as few as three satellite pseudo ranges, provided they are measured using a time reference. Since this is impractical with current GPS navigational platforms, the computation of location coordinates is generally accomplished using four pseudo ranges. This is illustrated in FIG. 1, where pseudo range information 15, 16, 17, 19 is used to determine the location coordinates of GPS receiver 10. Once the pseudo ranges for at least four GPS satellites have been determined, it is a straightforward process to determine the location coordinates of the GPS receiver.

FIG. 2 describes the data structure of the signal that is broadcast by each GPS satellite, where the signal contains 50 Hz data overlay signal—20 millisecond data bits modulating a one millisecond PRN code interval of 1023 bits or chips. The PRN code is known as a spreading code because it spreads the frequency spectrum of the GPS signal. This spread spectrum signal is known as a direct sequence spread spectrum (DSSS) signal.

Indoors, satellite signals suffer severe path losses as they are forced to penetrate windows, walls, and ceilings enroute to the receiver. Commercial buildings, in particular, introduce severe path losses (FIG. 3). Along the vertical, the roof and each intermediate floor contribute losses of estimated at 30 db. Exterior walls provide an estimated loss of 20 db, with interior walls adding 5 db each. Clearly, the indoor environment favors satellites near the horizon (over those directly above).

Indoors, and in urban canyons, the satellite signals reach the receiver by multiple paths. The result is a signal that is the composite of multiple instances of the transmitted signal, each reduced in power and differentially delayed. Absent the ability to isolate and recombine these reflected signals, the sensitivity of a receiver is effectively reduced. In strong signal communications applications, adaptive equalization techniques have been employed to combat the effects of multi-path—to prevent, for example the destructive combination of multiple instances of the transmitted signal, delayed relative to each other. To date, no such technology has been developed for applications in which the signal is buried in noise, such as satellite positioning. So, whereas a GPS receiver out in the clear is likely to see a single instance of a given satellite transmission, indoors the receiver is likely to see multiple variously-attenuated instances, delayed relative to each other, as shown in FIG. 4. The impact of this can be confounding to the prior art GPS receivers described in the paragraphs which follow.

FIG. 5 illustrates a block diagram of a prior art GPS receiver. The GPS signal from GPS satellite constellation 56 is received by the R/F front end 51 of GPS receiver 50. R/F front end 51 down converts the 1.57 GHz R/F signal, resulting in an intermediate frequency (I/F) signal. The streaming I/F signal is examined by a correlator or bank of correlators 52, employing a search algorithm to confirm the presence or absence, within the composite GPS signal, of component signals from the GPS satellites. In a typical search algorithm, the local frequency 53 is scanned across a range of frequencies; for each frequency, a series of correlations involving the incoming GPS signal and all possible code phases of a local replica 54 of the designated satellite's PRN code are used to “acquire” the designated satellite (i. e., determine the presence or absence of the designated satellite signal within the composite GPS signal). In order to ensure that the correct code phase is not missed due to local clock off-set, it is conventional to increment the local replica code phase in one-half chip or even smaller steps. The granularity of these steps is limited by the amount of over sampling that is performed on the incoming I/F signal. A high correlation peak value indicates that the designated satellite is present, and its signal, decodable. If no correlations peaks are high enough, the local frequency 53 is set to a second trial frequency and the correlations are repeated. Once pseudo range information has been obtained for at least four GPS satellites along with the corresponding satellite timing information, the coordinate generator 55 determines the three-dimensional location coordinates of the GPS receiver 50. There are a number of drawbacks to this approach, including a long time to first fix (TTFF) and reduced receive sensitivity in certain situations (e.g., those involving severe path loss).

To obtain a first fix, GPS receiver 50 must (1) acquire a minimum of four GPS satellites (three if a 2D fix is acceptable), by tuning the local frequency 53 and the code phase of the local PRN code replica 54 in the GPS receiver to match the carrier frequency and the PRN code phase of each of the electronically visible (i. e., decodable) satellites. The search for correlation peaks of sufficient strength to enable the extraction of reliable pseudo range information is a time-consuming process, in general, and failure-prone in indoor and urban canyon environments.

To minimize the TTFF of GPS receivers such as GPS receiver 50, the concept of a GPS assistance system has been introduced (see FIG. 6). The role of GPS assistance system 69 is to track, the satellites “acquirable” at the site of GPS assistance system 69, and provide assistance, in the form of frequency and phase information to GPS receiver 60 in the vicinity of GPS assistance system 69. As in the case of GPS receiver 50, the GPS signal from GPS satellite constellation 66 is received by the R/F front end 61 of GPS receiver 60. R/F front end 61 down converts the 1.57 GHz R/F signal, resulting in an intermediate frequency (I/F) signal. The streaming I/F signal is examined by a correlator or bank of correlators 62, which is used to acquire satellites. To expedite the acquisition process, carrier frequency and phase as well as PRN code phase information and decoded 50 Hz data derived by GPS assistance system 69, in the course of tracking acquirable satellites, is transmitted to GPS receiver 60. This information is used to initialize the search algorithm of correlator(s) 62, enabling the search algorithm to operate more efficiently and more effectively. As a result the TTFF is significantly reduced, and receive sensitivity is improved marginally, to the extent that information provided enables the acquisition of satellites otherwise electronically invisible (that is to say, their signals are not decodable) to GPS receiver 60. Once pseudo range information has been determined for four GPS satellites, the location coordinates are determined by coordinate generator 65.

As discussed earlier in the context of FIG. 3, satellites at or near the horizon are apt to be among the most electronically visible to GPS receiver 60 when indoors or in an urban canyon. To provide accurate and effective information to GPS receiver 60 under these circumstances, it is critical that GPS assistance system 69, provide accurate carrier frequency and phase as well as PRN code phase information and decoded 50 Hz data for satellites at or near the horizon, notwithstanding the challenges implicit in this requirement.

Since neither GPS receiver 50 nor GPS receiver 60 has demonstrated the capability of providing reliable indoor and urban canyon operation, there is a need in the art for a method of improving the receive sensitivity of GPS-enabled devices, consistent with the requirements of the emerging E-911, asset management, and location-based consumer applications.

### BRIEF SUMMARY OF THE INVENTION

In general, the object of the present invention is to provide methods and apparatus to increase the accuracy of carrier frequency and phase as well as the PRN code phase information and decoded 50 Hz data provided by GPS assistance systems to target GPS receivers to enable more rapid and reliable operation in indoor and urban canyon environments. To the extent that the satellites electronically visible to target GPS receivers inside commercial buildings are likely to be near the horizon, where the acquisition and tracking of satellites near the horizon is peculiarly challenging for prior-art GPS assistance systems, novel techniques for reducing the minimum signal strength required by GPS assistance systems to acquire and accurately track satellites near the horizon are disclosed. The use of multiple GPS sensors provides the conceptual framework for such techniques. In this context, a GPS sensor consists of an antenna and an RF front end. To eliminate confusion, GPS sensors are characterized as one of two types: target GPS sensors, whose location is to be determined; and reference GPS sensors, used by a GPS assistance system to accurately track all satellites visible to target GPS receivers, enabling the GPS assistance system to provide accurate carrier frequency and phase as well as PRN code information to target GPS receivers, be they indoors or out.

The reduction in the minimum signal strength required by a GPS assistance system to acquire and accurately track a satellite near the horizon is obtained by mitigating the deleterious effects of strong satellite signals (typically from overhead satellites) on the tracking of weaker satellite signals (typically from satellites near the horizon). The potential for strong satellite signals to interfere in the tracking of weak satellite signals is an artifact of the correlation process which serves as the foundation for GPS satellite signal acquisition and tracking techniques.

The solution to this strong signal interference problem (as disclosed herein) involves techniques to synthesize, from the composite GPS satellite signal, satellite-specific signals, each with the strongest potentially-interfering satellite signals suppressed. By suppressing the potentially-interfering satellite signals, the prominent cross correlation peaks are suppressed, as shown in FIG. 18. The techniques to synthesize, from the composite GPS satellite signal, satellite-specific signals, each with the strongest potentially-interfering signals suppressed, take the form of Strong Signal Attenuation Subsystems (SSAS), incorporating multiple reference GPS sensors.

Strong Signal Attenuation Subsystems can be classified in terms of the type of antenna deployed with the reference GPS sensors. The antennae may be uni-directional or omni-directional. Accordingly, the techniques embodied in the Strong Signal Attenuation Subsystems disclosed herein are specific to the type of antenna deployed with the reference GPS sensors. For the sake of brevity, this disclosure focuses on homogeneous GPS sensor/antenna deployments; that is, SSAS deploying either uni-directional or omni-directional antennae. SSAS deploying a mix of uni-directional and omni-directional antennae are rational systems, implemented straightforwardly using the teachings of this disclosure.

In the case that uni-directional antennae are deployed, the invention postulates a hemisphere (with its origin in the neighborhood of the target receiver) partitioned into N+1 elements, corresponding to the directional attributes of N+1 antennae deployed with N+1 reference GPS sensors. Each of the reference GPS sensors down converts the composite satellite signal, yielding the I/F signal (bit stream) appropriate to the acquisition of the satellite or satellites within the field of view of its directional antenna. In one embodiment (FIG. 7), the outputs of the reference GPS sensors are multiplexed (MUX 72), producing, in sequence, the I/F signal for each of the M satellites hemispherically available (i. e., likely to be decodable based on time and trajectory) to the SSAS. In another embodiment (FIG. 8), the outputs of the reference GPS sensors are multiplexed (MUX 82), producing, simultaneously, the I/F signals for each of the M hemispherically available satellites.

In the case that omni-directional antennae are deployed, the invention postulates the capability to suppress at least N of the strongest potentially-interfering satellite signals to enable the acquisition of a weak satellite signal. Accordingly, N+1 reference GPS sensors are deployed. Each of the reference GPS sensors down converts the (composite) satellite signal, yielding an I/F signal (bit stream) which, together with the I/F signals from the remaining N reference GPS sensors, enables the synthesis of I/F signal(s) appropriate to the acquisition of weak satellite signal(s). The synthesis involves the use of novel signal processing techniques to realize the I/F signal(s) corresponding to one or more designated satellites, with at least N of the strongest potentially-interfering satellite signals suppressed. In FIG. 9, these techniques, embodied in Strong Signal Suppressor 92, produce, in sequence, the I/F signals appropriate to the acquisition of each of the M satellites hemispherically available to the SSAS. In another embodiment (FIG. 10), the I/F signals for each of the M available satellites are produced simultaneously, each with at least N of the strongest potentially-interfering satellite signals suppressed.

FIG. 11 describes the application of a Strong Signal Attenuation Subsystem within a GPS assistance system. The Strong Signal Attenuation Subsystem enables the GPS assist system 119 to more precisely quantify the carrier frequency and phase as well as the code phase of signals from satellites near the horizon—owing to the fact that potentially-interfering overhead satellite signals have been suppressed in the I/F signals corresponding to satellites at or near the horizon, enabling the bank of correlators 115 to function efficiently and effectively.

In accordance with the present invention, a strong signal attenuation system for deriving GPS satellite-specific I/F signals from the composite GPS satellite transmission, enabling more efficient and effective acquisition of said GPS satellites, is presented, comprising:
multiple reference GPS sensors, each with a uni-directional antenna and front end for down converting composite GPS satellite signals into GPS satellite-specific I/F signals, and
multiplexing means for selecting one or more of the GPS satellite-specific I/F signals produced by the reference GPS sensors, for input to a GPS satellite acquisition system.

In accordance with the present invention, a strong signal attenuation system for synthesizing GPS satellite-specific I/F signals from the composite GPS satellite transmission, enabling more efficient and effective acquisition of said GPS satellites, is presented, comprising:
multiple reference GPS sensors, each with an omni-directional antenna and front end for down converting composite GPS satellite signals into I/F signals, and
strong signal suppression means for synthesizing, from the I/F signals produced by said reference GPS sensors, a set of one or more GPS satellite-specific I/F signals, each with one or more of the strongest potentially-interfering GPS satellite signals suppressed, for input to a GPS satellite acquisition system.

In accordance with the present invention, a GPS assistance system, for providing accurate satellite-specific carrier frequency and phase as well as PRN code phase information and decoded 50 Hz data to GPS receivers in the vicinity of said GPS assistance system, is presented, comprising:
strong signal attenuation means for generating one or more GPS satellite-specific I/F signals, enabling more efficient and effective acquisition of said navigation satellites;
correlation means for the purpose of deriving, from the one or more GPS satellite-specific I/F signals generated by said strong signal attenuation means, accurate satellite-specific carrier frequency and phase as well as PRN code phase information and decoded 50 Hz data for use by GPS receivers in the vicinity of said strong signal attenuation means; and
control means for controlling the strong signal attenuation means.

Those skilled in the art will understand that the strong signal suppression means may be implemented in mixed signal circuitry, including logic circuits and/or a microprocessor with appropriate software or firmware. Further, those skilled in the art will understand that the methods and apparatus of the present invention may be applied to satellite positioning systems evolved from the GPS satellite positioning system, including but not limited to the Galileo and Glasnost systems.

Various aspects and features of the present invention may be understood by examining the drawings here listed.

### BRIEF DESCRIPTION OF THE DRAWINGS

FIG. 1 shows the system diagram of a GPS satellite positioning system (SPS)

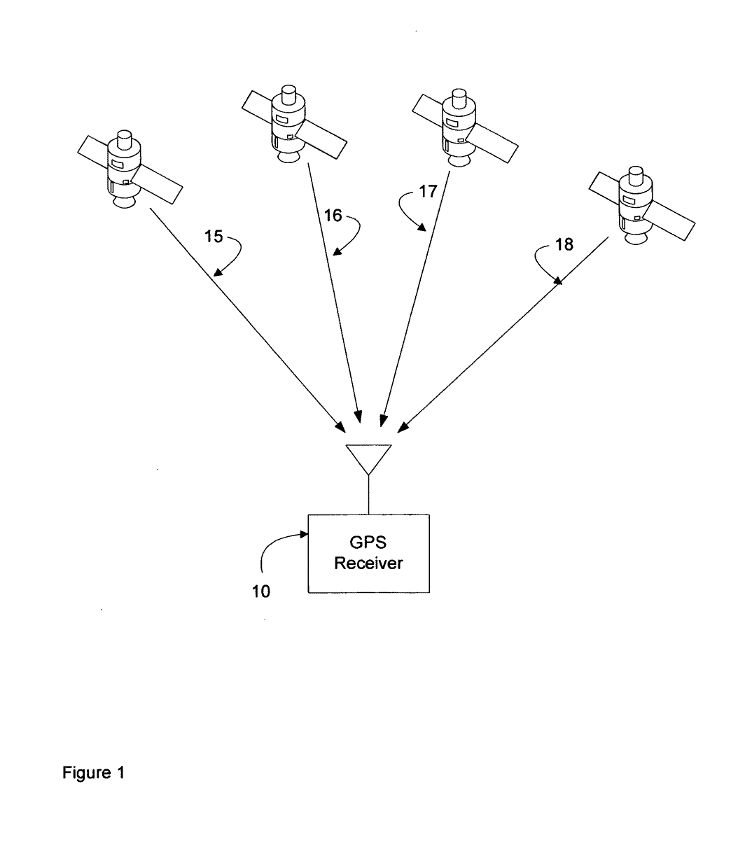

FIG. 2 describes the data structure transmitted by a GPS satellite

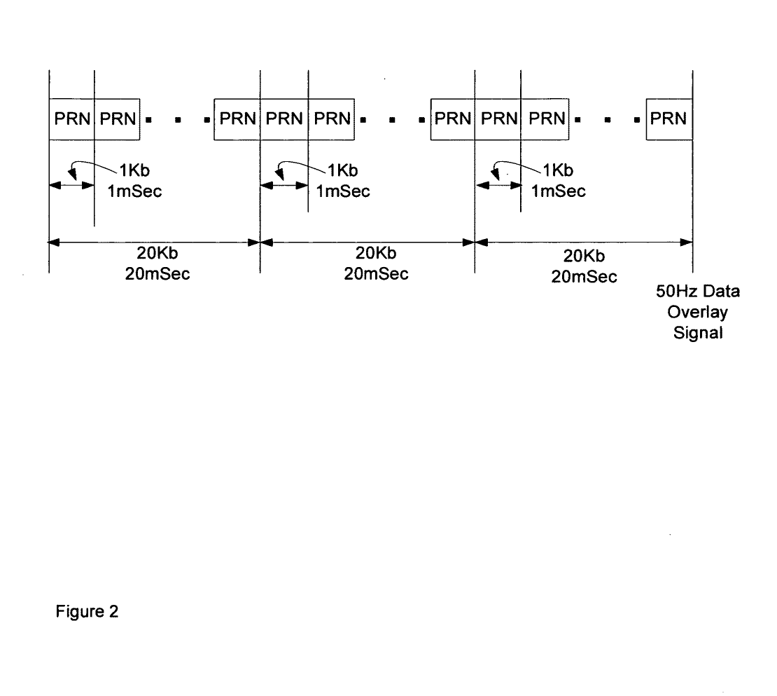

FIG. 3 illustrates the nature of path losses experienced by satellite signals penetrating commercial buildings

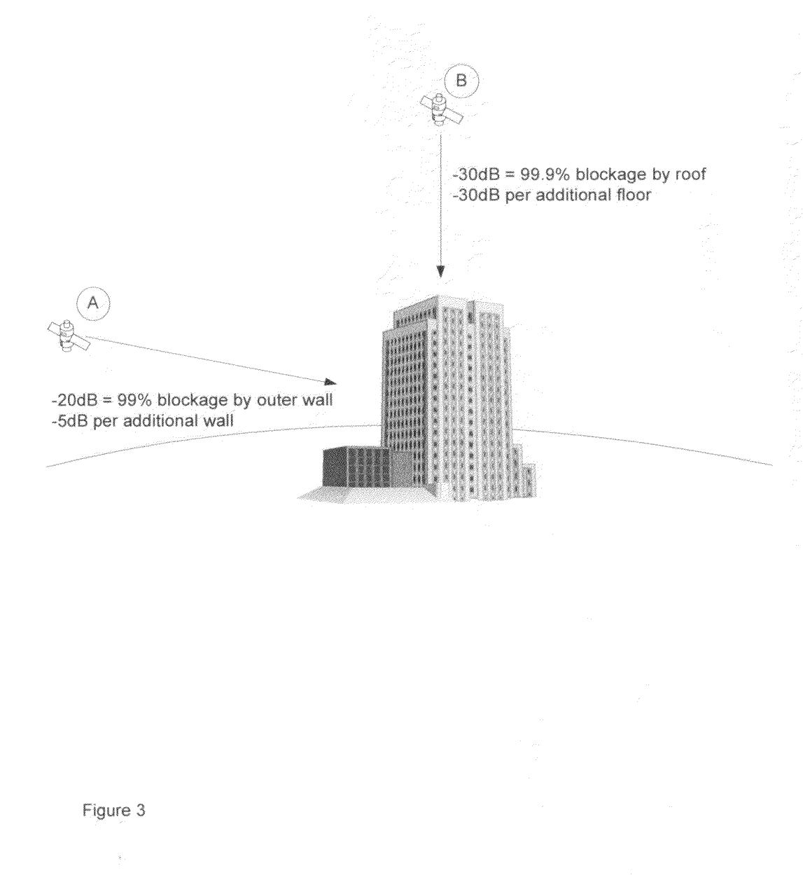

FIG. 4 illustrates the signal degradation resulting from multi-path

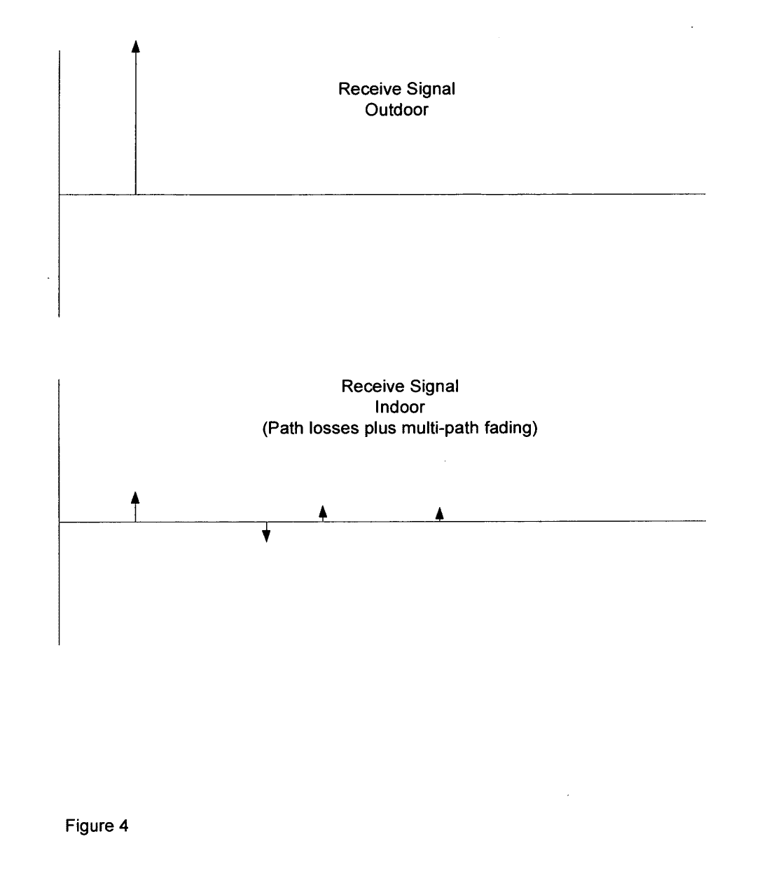

FIG. 5 shows a block diagram of a prior art GPS receiver

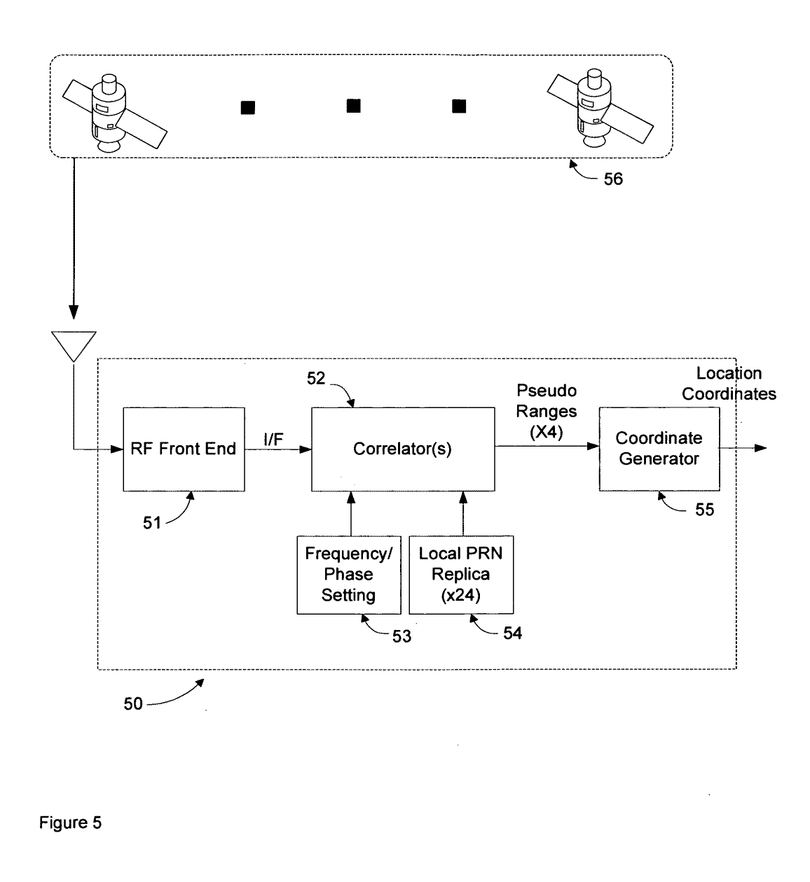

FIG. 6 shows a block diagram of a prior art assisted-GPS receiver

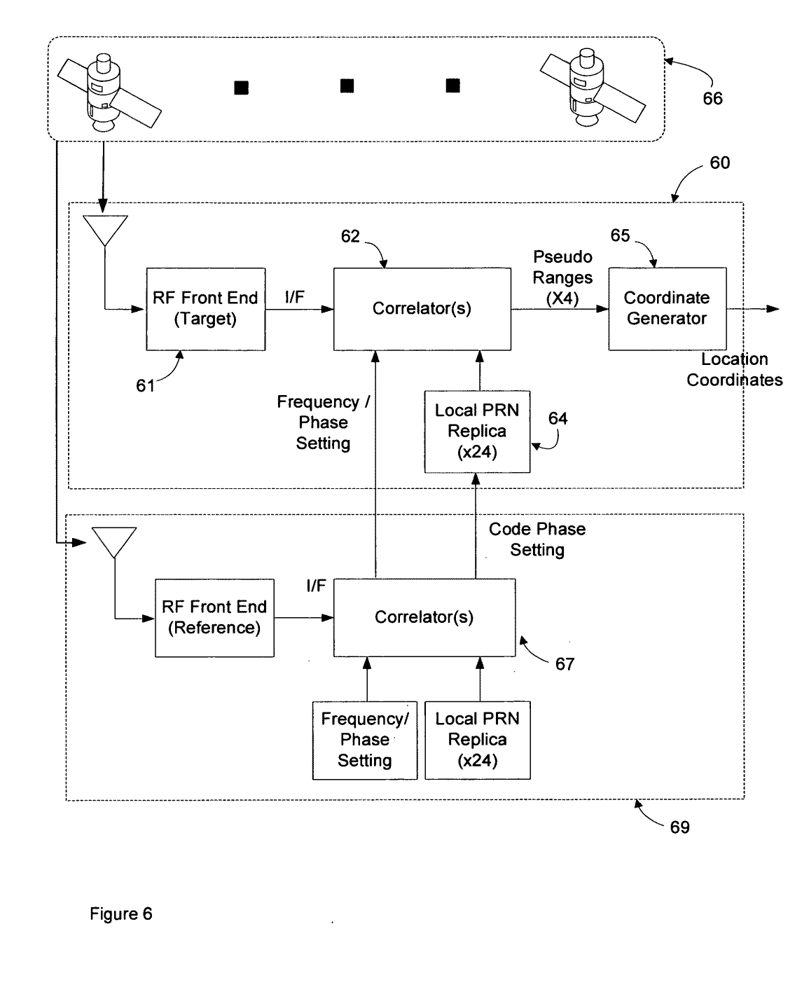

FIG. 7 shows a block diagram of a Strong Signal Attenuation Subsystem

FIG. 8 shows a block diagram of a Strong Signal Attenuation Subsystem

FIG. 9 shows a block diagram of a Strong Signal Attenuation Subsystem

FIG. 10 shows a block diagram of a Strong Signal Attenuation Subsystem

FIG. 11 shows a block diagram of a satellite positioning system (SPS) employing the present invention

FIG. 12 shows a block diagram of a satellite positioning system (SPS) employing the present invention

FIG. 13 shows a block diagram of a satellite positioning system (SPS) employing the present invention

FIG. 14 shows a block diagram of a satellite positioning system (SPS) employing the present invention

FIG. 15 describes the output of a correlator

FIG. 16 describes the output of a correlator

FIG. 17 describes the output of a correlator

FIG. 18 describes the output of a correlator

FIG. 19 describes one construction of a Strong Signal Suppressor

### DETAILED DESCRIPTION OF THE INVENTION

In general, the object of the present invention is to provide methods and apparatus to increase the accuracy of carrier frequency and phase as well as PRN code phase information and decoded 50 Hz data provided by GPS assistance systems to target GPS receivers to enable more rapid and reliable operation in indoor and urban canyon environments. To the extent that the satellites electronically visible to target GPS receivers inside commercial buildings are likely to be near the horizon, even as the acquisition and tracking of satellites near the horizon is peculiarly challenging for prior-art GPS assistance systems, novel techniques for reducing the minimum signal strength required by GPS assistance systems to acquire and accurately track satellites near the horizon are disclosed. The use of multiple GPS sensors provides the conceptual framework for such techniques. In this context, a GPS sensor consists of an antenna and an RF front end. To eliminate confusion, GPS sensors are characterized as one of two types: target GPS sensors, whose location is to be determined; and reference GPS sensors, used by a GPS assistance system to accurately track all satellites visible to target GPS receivers, enabling the GPS assistance system to provide accurate carrier frequency and phase as well as PRN code phase information and decoded 50 Hz data to target GPS receivers, be they indoors or out.

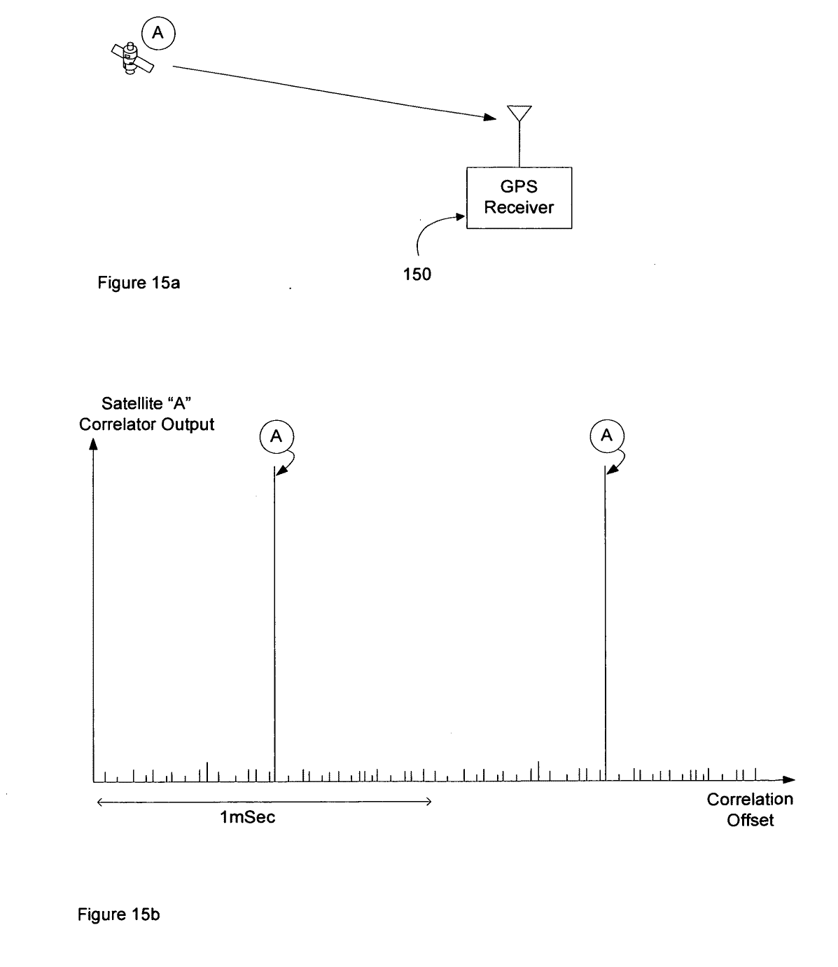

The reduction in the minimum signal strength required by a GPS assistance system to acquire and accurately track a satellite near the horizon is obtained by mitigating the deleterious effects of strong satellite signals (typically from overhead satellites) on the tracking of weaker satellite signals (typically from satellites near the horizon). The potential for strong satellite signals to interfere in the tracking of weak satellite signals is an artifact of the correlation process which serves as the foundation for GPS satellite signal acquisition and tracking techniques. This is illustrated in FIGS. 15-18.

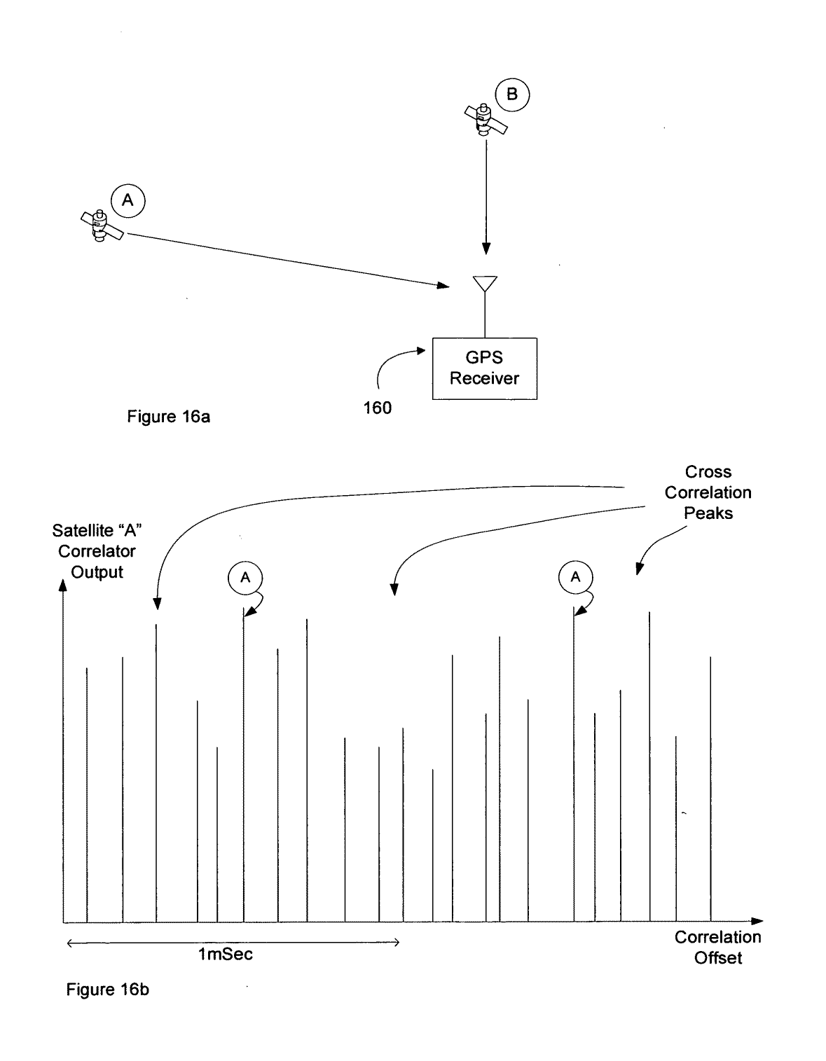

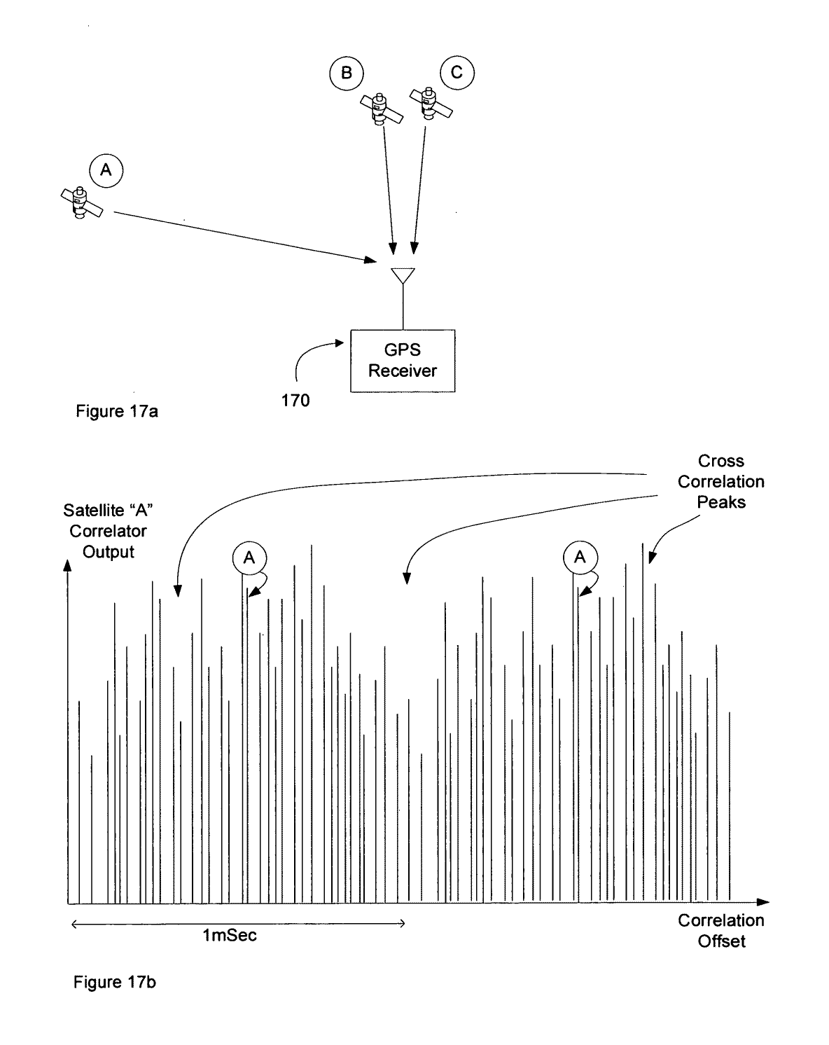

The signals transmitted by GPS satellites carry satellite-specific encodings. By correlating the down-converted (composite) GPS satellite signal with the satellite-specific PRN codes of available satellites, a GPS assistance system determines the relative delays incurred in each satellite transmission. The relative delays are measured in terms of the relative displacement of the autocorrelation peaks generated for the available satellites. FIG. 15 describes the output of the correlation of the (composite) GPS satellite signal with the PRN code for weak satellite A, as it would appear if all other GPS satellites were turned off. A distinct peak in the correlator output marks the presence of (a signal from) satellite A. In FIG. 16, strong satellite B has been turned on, and the output of the correlator has changed, revealing prominent cross correlation peaks owing to the relative strength of (the signal from) satellite B. In FIG. 17, a second strong satellite C has been turned on, adding additional prominent cross correlation peaks to the correlator output.

As the figure illustrates, the search for the autocorrelation peak corresponding to weak satellite A is complicated if not completely frustrated by the prominent cross correlation peaks introduced by the strong satellites B and C. Under these circumstances, a GPS assistance system may be unable to provide useful information on weak satellite A to target GPS receivers in its vicinity. On its surface, this does not appear to be a serious limitation: “How important can it be to provide assistance in the acquisition of weak satellites, especially if the strong satellite information is accurate?”

The answer to this question depends, of course, on the circumstance of the target GPS receiver. When the target receiver is indoors, especially on the lower floors of a multi-story commercial building, this information is likely to be critical, as the only satellites acquirable may be those near the horizon—the same satellites that may have been compromised by stronger overhead satellites at the site of the GPS assistance system.

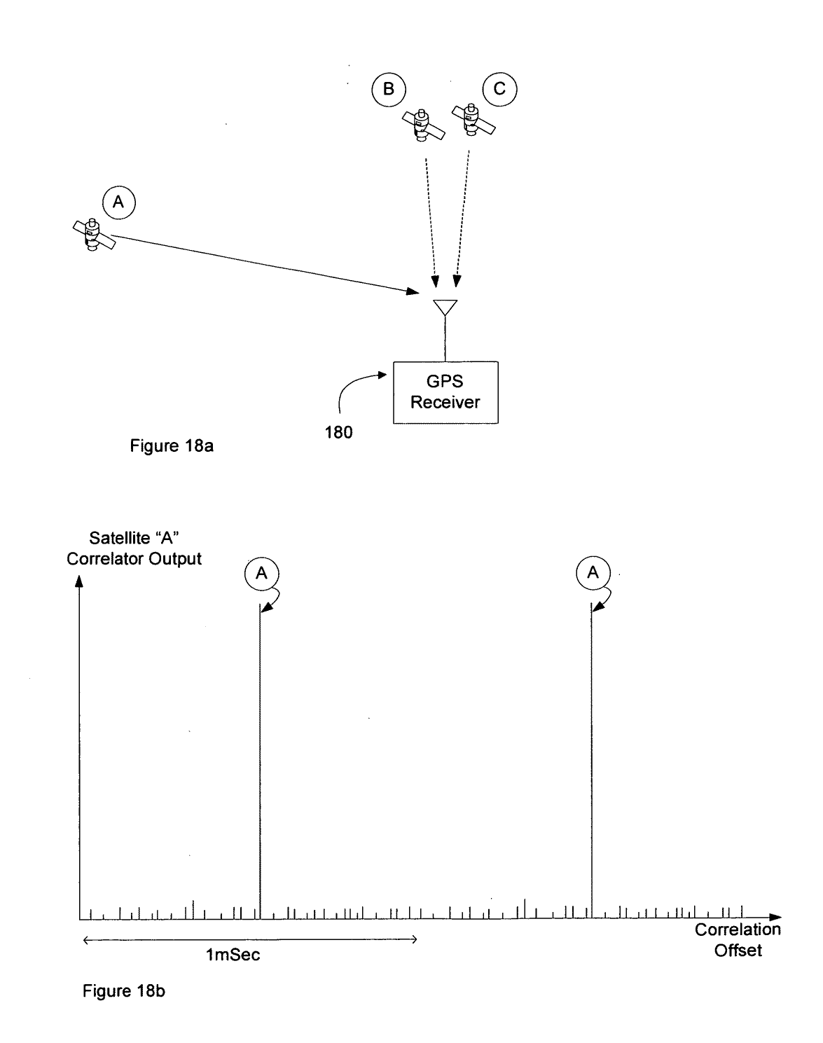

The solution to this strong signal interference problem (as disclosed herein) involves techniques to synthesize, from the (composite) GPS satellite signal, satellite-specific signals, each with the strongest potentially-interfering satellite signals suppressed. By suppressing the potentially-interfering satellite signals, the prominent cross correlation peaks are suppressed, as shown in FIG. 18. The techniques to synthesize, from the (composite) GPS satellite signal, satellite-specific signals, each with the strongest potentially-interfering signals suppressed, take the form of Strong Signal Attenuation Subsystems (SSAS), incorporating multiple reference GPS sensors.

Strong Signal Attenuation Subsystems can be classified in terms of the type of antenna deployed with the reference GPS sensors. The antennae may be uni-directional or omni-directional. Accordingly, the techniques embodied in the Strong Signal Attenuation Subsystems disclosed herein are specific to the type of antenna deployed with the reference GPS sensors. For the sake of brevity, this disclosure focuses on homogeneous GPS sensor/antenna deployments; that is, SSAS deploying either uni-directional or omni-directional antennae. SSAS deploying a mix of uni-directional and omni-directional antennae are rational systems, implemented straightforwardly using the teachings of this disclosure.

In the case that uni-directional antennae are deployed, the invention postulates a hemisphere (with its origin in the neighborhood of the SSAS) partitioned into N+1 elements, corresponding to the directional attributes of N+1 antennae deployed with N+1 reference GPS sensors. Each of the reference GPS sensors down converts the (composite) satellite signal, yielding the I/F signal (bit stream) appropriate to the acquisition of the satellite or satellites within the field of view of its directional antenna. To illustrate one example of hemisphere partitioning, consider 9 GPS sensors/antennae—2 pointed North, 2 pointed East, 2 pointed South, 2 pointed West, and one pointed upward—with each pair able to “see” 45 degrees to either side of its horizontal aiming point. If each pair is further constructed to cover complementary elevations (e.g., 0-30 degrees and 30-60 degrees), the hemisphere is covered completely. This partitioning provides 4 GPS sensors for near-horizon satellites, and 5 for overhead satellites. With its knowledge of the approximate locations of all the hemispherically available satellites at all times, the SPS system maintains an up-to-the-minute table of available satellites with their corresponding GPS sensors. (Note that this mapping need not be 1 for 1, as the partitioning of the hemisphere may not preclude the presence of multiple satellites within the field of view of a single GPS sensor.)

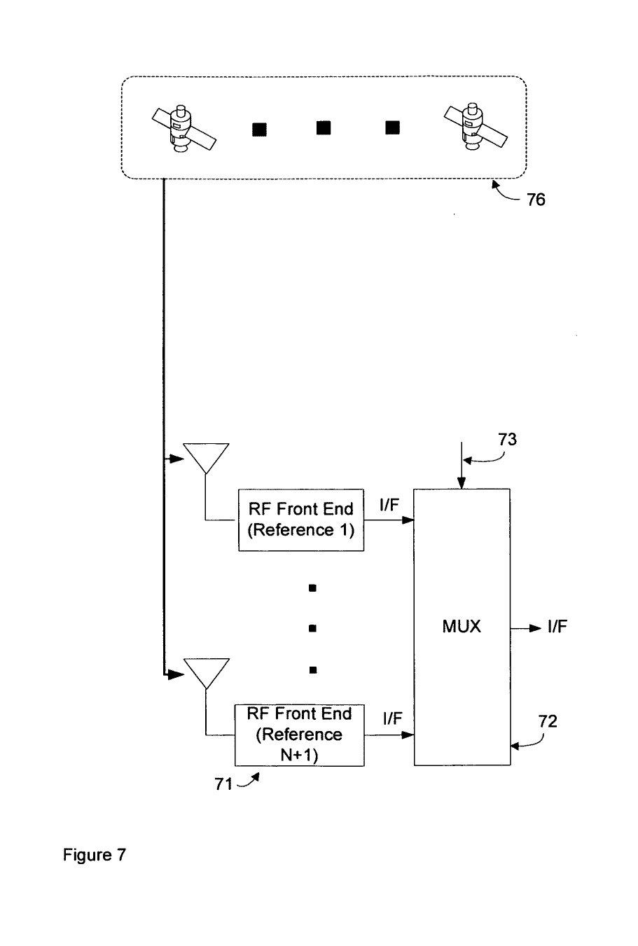

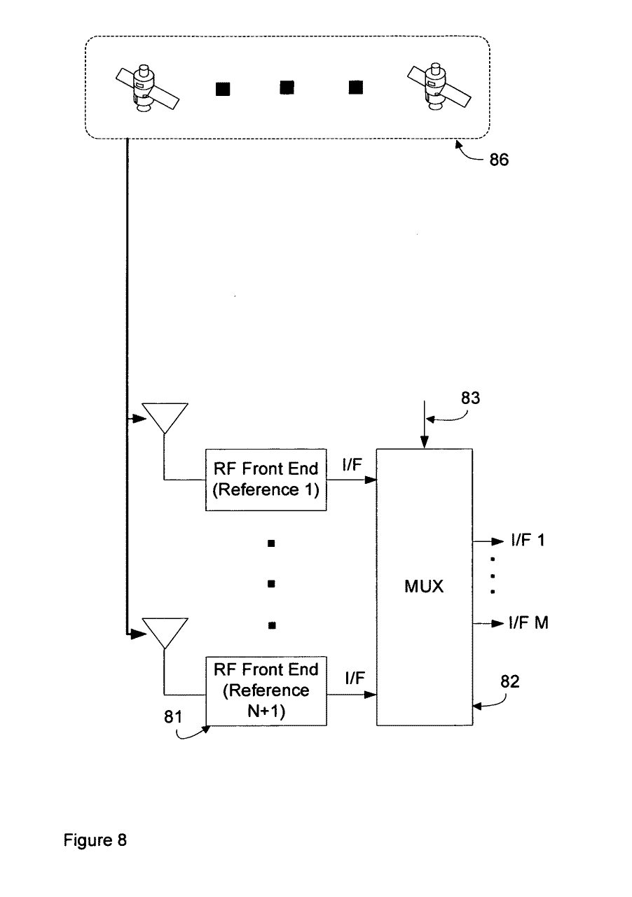

FIG. 7 describes one embodiment of an SSAS constructed with uni-directional antennae. The outputs of the reference GPS sensors are multiplexed (MUX 72), producing, in sequence, the I/F signal for each of the M satellites hemispherically available to the SSAS. In this case, the minimum number of correlators is determined by the maximum number of satellites expected within the field of view of any one of the directional antennae. In another embodiment (FIG. 8), the outputs of the reference GPS sensors are multiplexed (MUX 82), producing, simultaneously, the I/F signals for each of the M hemispherically available satellites. Here the minimum number of correlators is determined by the maximum number of satellites hemispherically available. In either case, GPS assistance system's the up-to-the-minute mapping of satellites to GPS sensors is applied to control the MUX.

In the case that omni-directional antennae are deployed, the invention postulates the capability to suppress at least N of the strongest potentially-interfering satellite signals to enable the acquisition of a weak satellite signal. Accordingly, N+1 reference GPS sensors are deployed. Each of the reference GPS sensors down converts the (composite) satellite signal, yielding an I/F signal (bit stream) which, together with the I/F signals from the remaining N reference GPS sensors, enables the synthesis of I/F signal(s) appropriate to the acquisition of weak satellite signal(s). The synthesis involves the use of novel signal processing techniques to realize the I/F signal(s) corresponding to one or more designated satellites, each with N of the strongest potentially-interfering satellite signals suppressed. These techniques are embodied within a subsystem characterized as a Strong Signal Suppressor (SSS).

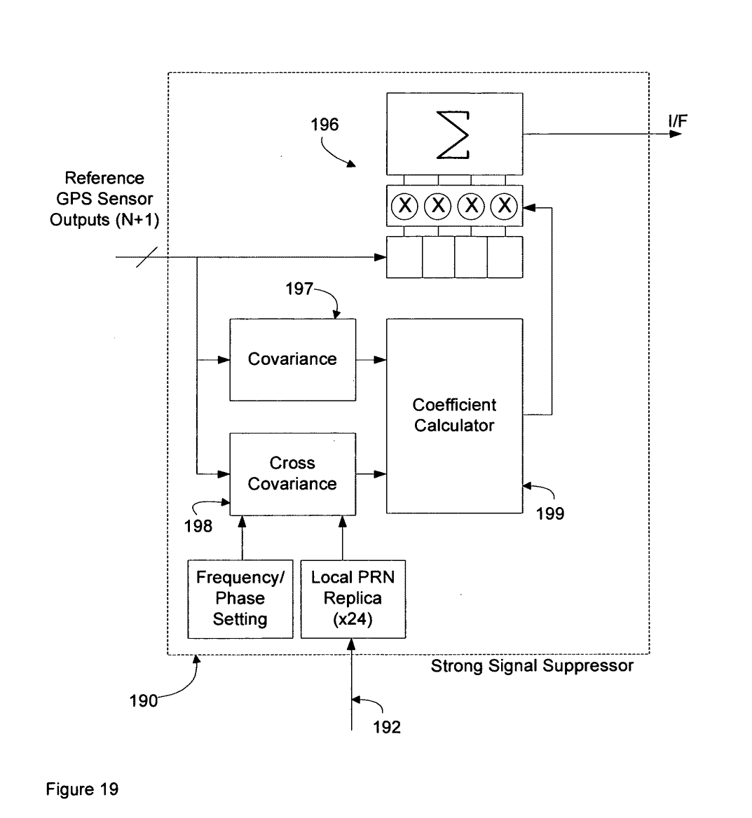

The Strong Signal Suppressor incorporates one or more I/F signal synthesis engines together with the logic to control them. The control logic serves to initialize the synthesis engine(s) for the synthesis of the desired I/F signal(s). An example of one such engine is described in FIG. 19.

With input from N+1 reference GPS sensors, Strong Signal Suppressor 190 synthesizes a single I/F signal corresponding to the satellite-specific PRN code provided. The I/F signal is synthesized as a weighted sum of the N+1 reference GPS sensor inputs. The weighting coefficients are generated from a covariance matrix common for all satellites and a cross covariance matrix for each desired signal. Where it is desired to simultaneously synthesize M I/F signals, this engine could be replicated M times. Alternatively, a multi-output equivalent might be employed.

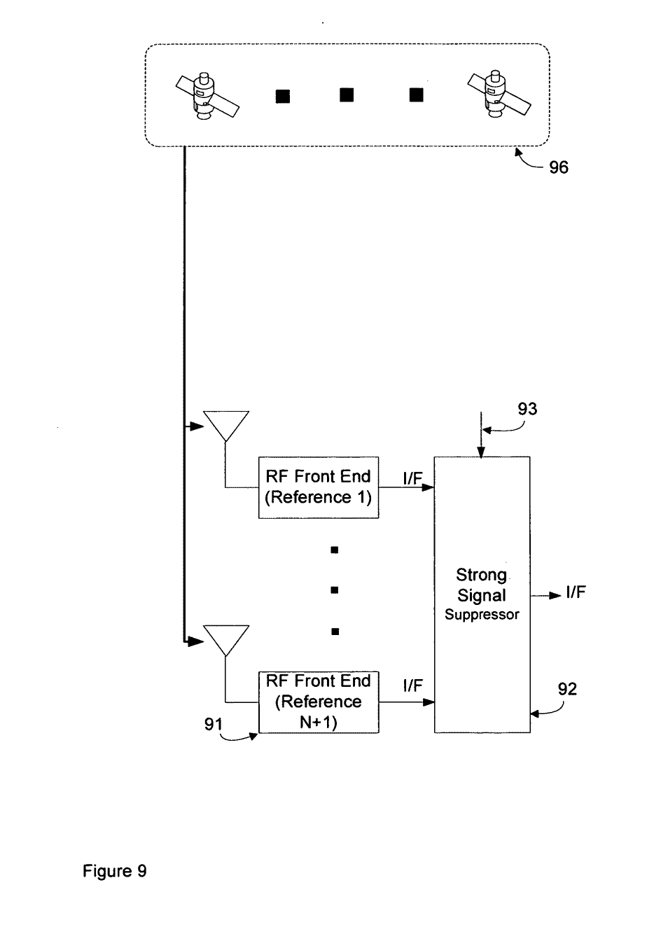

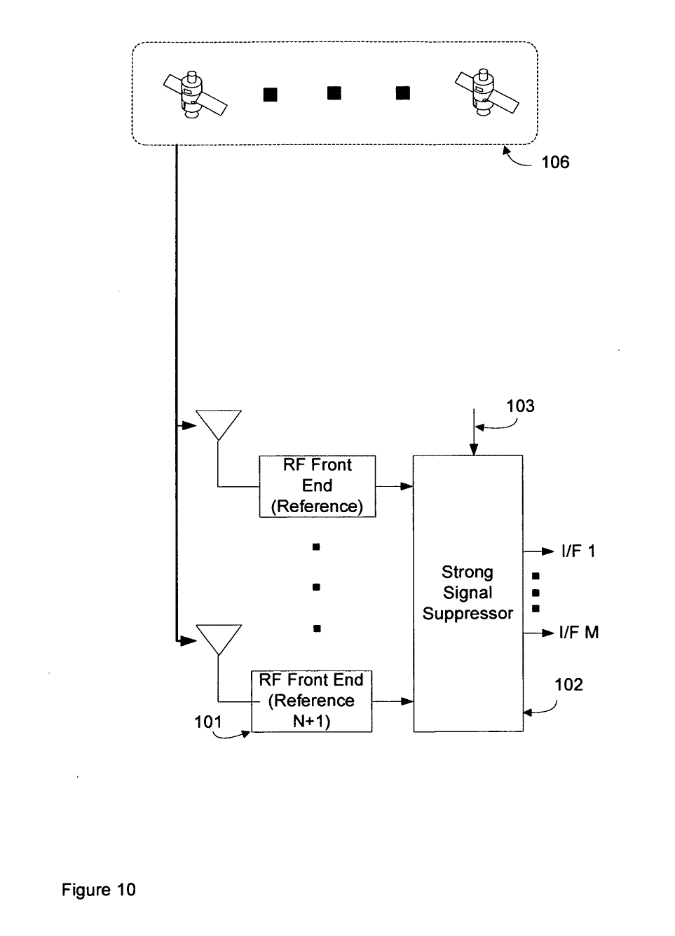

In FIG. 9, Strong Signal Suppressor 92, produces, in sequence, the I/F signals appropriate to the acquisition of each of M satellites hemispherically available to the SSAS. Each of the satellite-specific I/F signals is synthesized with at least N of the strongest potentially-interfering satellite signals suppressed. In another embodiment (FIG. 10), the I/F signals for each of the M hemispherically available satellites are produced simultaneously, each with at least N of the strongest potentially-interfering satellite signals suppressed. In this case, the minimum number of correlators is determined by the maximum number of satellites hemispherically available at any instance in time. In either case, the GPS assistance system's up-to-the-minute enumeration of hemispherically available satellites is applied to control the SSS.

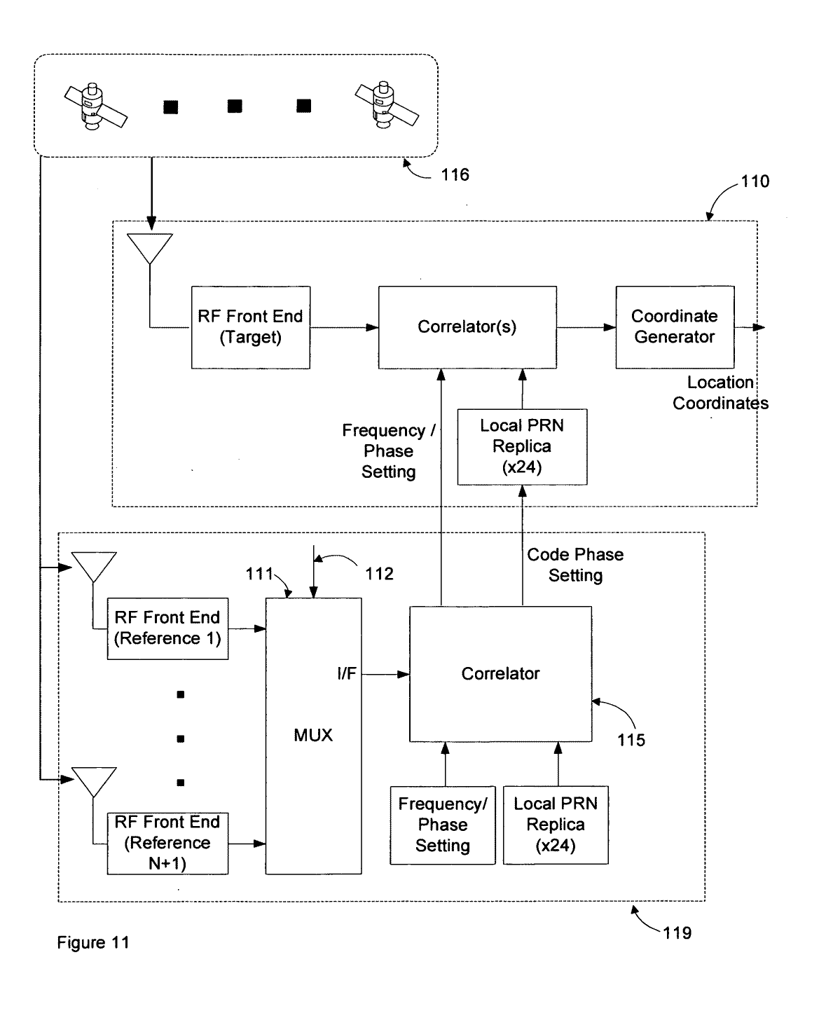

FIG. 11 describes the application of a Strong Signal Attenuation Subsystem within GPS assistance system 119. N+1 uni-directional antennae feed N+1 front ends, the outputs of which are multiplexed by MUX 111 into the correlator 115. The control 112 of MUX 111 sequences the I/F signals out of the front ends so that the signals of all the hemispherically available satellites may be acquired in turn. Accordingly, the Strong Signal Attenuation Subsystem enables the GPS assistance system 119 to more precisely quantify the carrier frequency and phase as well as the PRN code phase information and decoded 50 Hz data of signals from satellites near the horizon—owing to the fact that potentially-interfering overhead satellite signals have been attenuated in the I/F signals corresponding to the satellites at or near the horizon, enabling the correlator 115 to function efficiently and effectively.

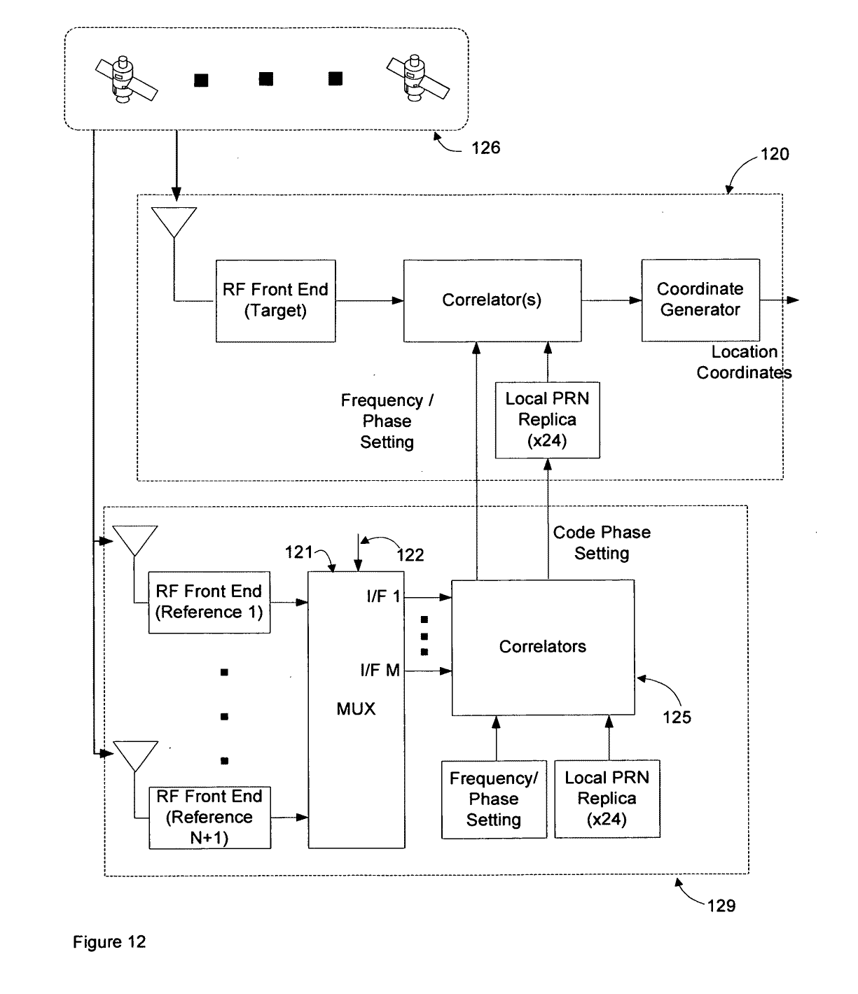

FIG. 12 describes the application of a Strong Signal Attenuation Subsystem within GPS assistance system 129. N+1 uni-directional antennae feed N+1 front ends, the outputs of which are multiplexed by MUX 121 into the bank of correlators 125. The control 122 of MUX 121 multiplexes the I/F signals from the front ends, into the bank of correlators in such manner as to insure that all the hemispherically available satellites may be acquired simultaneously. The minimum number of correlators is determined by the maximum number of satellites hemispherically available. Accordingly, the Strong Signal Attenuation Subsystem enables the GPS assistance system 129 to more precisely quantify the carrier frequency and phase as well as the PRN code phase information and decoded 50 Hz data of signals from satellites near the horizon—owing to the fact that potentially-interfering overhead satellite signals have been attenuated in the I/F signals corresponding to satellites at or near the horizon, enabling the bank of correlators 125 to function efficiently and effectively.

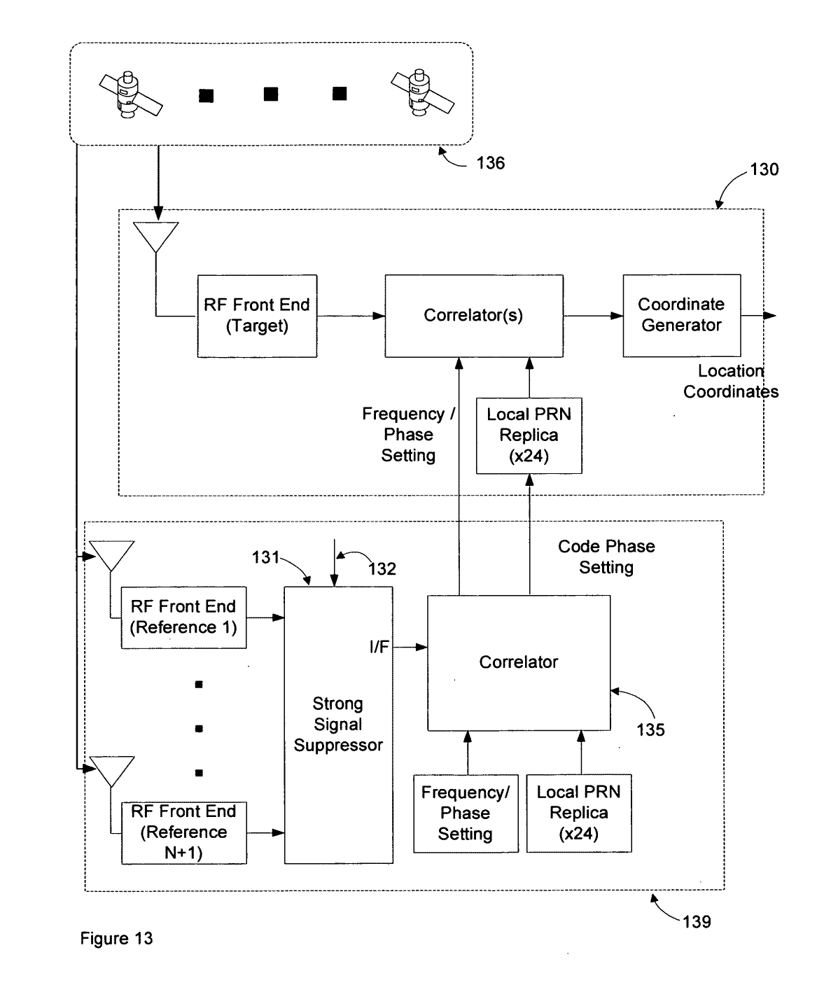

FIG. 13 describes the application of a Strong Signal Attenuation Subsystem within GPS assistance system 139. N+1 omni-directional antennae feed N+1 front ends, the outputs of which are input to Strong Signal Suppressor 141, where I/F signal(s) appropriate to the acquisition of the M satellites hemispherically available to a target GPS receiver, are synthesized. In the synthesis of each of the M satellite-specific I/F signals, at least N of the strongest potentially-interfering satellite signals are suppressed. The control 132 of SSS 131 insures that satellite-specific I/F signals of the M satellites hemispherically available to the SSAS are presented to correlator 135 in sequence. Accordingly, the Strong Signal Attenuation Subsystem enables the GPS assistance system 139 to more precisely quantify the carrier frequency and phase as well as the PRN code phase information and decoded 50 Hz data of signals from satellites near the horizon—owing to the fact that potentially-interfering overhead satellite signals have been suppressed in the I/F signals corresponding to satellites at or near the horizon, enabling correlator 135 to function efficiently and effectively.

In another embodiment, the I/F signals for each of M satellites electronically available to a target GPS receiver are produced, in sequence, each with at least N of the strongest potentially-interfering satellite signals suppressed. The presumption here is that the target GPS receiver is capable of communicating to the GPS assistance system an enumeration of the satellites electronically available to it, perhaps in decreasing order of signal strength, enabling the GPS assistance system, via the SSAS, to prioritize the delivery of up-to-the-minute information on the M satellites most electronically visible to a target GPS receiver.

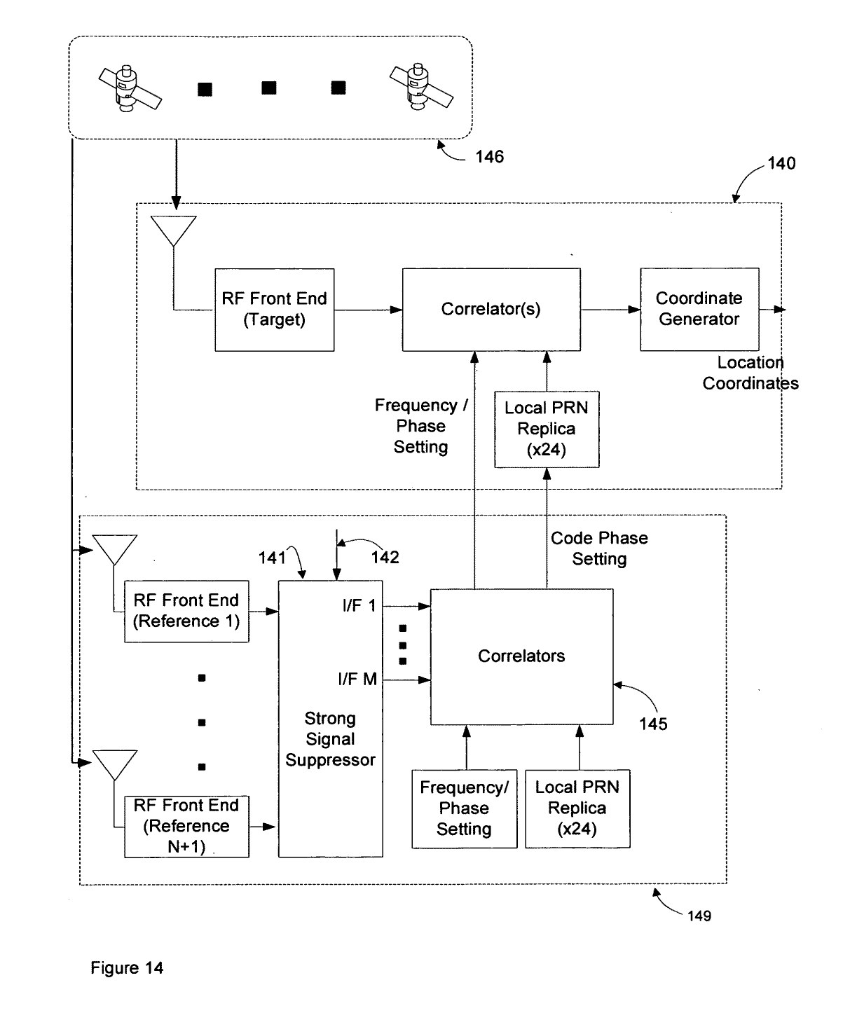

FIG. 14 describes the application of a Strong Signal Attenuation Subsystem within GPS assistance system 149. N+1 omni-directional antennae feed N+1 front ends, the outputs of which are input to Strong Signal Suppressor 141, where I/F signal(s) appropriate to the acquisition of the M satellites hemispherically available to a target GPS receiver, are synthesized. In the synthesis of each of the M satellite-specific I/F signals, at least N of the strongest potentially-interfering satellite signals are suppressed. The control 142 of SSS 141 insures that satellite-specific I/F signals of the M satellites hemispherically available to the SSAS are presented to the bank of correlators 145 simultaneously. In this case, the Strong Signal Attenuation Subsystem enables the GPS assistance system 149 to more precisely quantify the carrier frequency and phase as well as the PRN code phase information and decoded 50 Hz data of signals from satellites near the horizon—owing to the fact that potentially-interfering overhead satellite signals have been suppressed in the I/F signals corresponding to the satellites at or near the horizon, enabling the bank of correlators 145 to function efficiently and effectively.

In another embodiment, the I/F signals for each of M satellites electronically available to a target GPS receiver are produced, simultaneously, each with at least N of the strongest potentially-interfering satellite signals suppressed. The presumption here is that the target GPS receiver is capable of communicating to the GPS assistance system an enumeration of the satellites electronically available to it, perhaps in decreasing order of signal strength, enabling the GPS assistance system, via the SSAS, to prioritize the delivery of up-to-the-minute information on the M satellites most electronically visible to the target GPS receiver.

We claim:

1. A strong signal attenuation system for deriving GPS satellite-specific I/F signals from the composite GPS satellite transmission, enabling more efficient and effective acquisition of said GPS satellites, comprising:
multiple reference GPS sensors, some or all with uni-directional antennae and front ends for down converting composite GPS satellite signals into GPS satellite-specific I/F signals, and
multiplexing means for selecting one or more of the GPS satellite-specific I/F signals produced by said reference GPS sensors, for input to a GPS satellite acquisition system.

2. The strong signal attenuation system of claim 1, wherein the multiple reference GPS sensors, collectively, provide complete coverage of the hemisphere above the reference GPS sensors.

3. The strong signal attenuation system of claim 1, wherein the multiplexing means selects the one or more GPS satellite-specific I/F signals corresponding to a set of one or more GPS satellites designated for acquisition.

4. The strong signal attenuation system of claim 1, wherein the GPS satellite acquisition system is a bank of one or more correlators.

5. A strong signal attenuation system for synthesizing GPS satellite-specific I/F signals from the composite GPS satellite signal, enabling more efficient and effective acquisition of said GPS satellites, comprising:
multiple reference GPS sensors, some or all with omni-directional antennae and front ends for down converting composite GPS satellite signals into I/F signals, and
strong signal suppression means for synthesizing, from the I/F signals produced by said reference GPS sensors, a set of one or more GPS satellite-specific I/F signals, each with one or more of the strongest potentially-interfering GPS satellite signals suppressed, for input to a GPS satellite acquisition system.

6. The strong signal attenuation system of claim 5, wherein the number of reference GPS sensors is N+1, and the number of potentially-interfering GPS satellite signals suppressed is at least N.

7. The strong signal attenuation system of claim 5, wherein the strong signal suppression means synthesizes the set of one or more GPS satellite-specific I/F signals corresponding to a set of one or more GPS satellites designated for acquisition.

8. A method for deriving GPS satellite-specific I/F signals from the composite GPS satellite signal, enabling more efficient and effective acquisition of said GPS satellites, said method comprising:
hemispherically visible GPS satellite iteration over a set of hemispherically visible GPS satellites, and
for each hemispherically visible GPS satellite, connection via MUX of the I/F signals produced by selected omni-directional reference GPS sensors to a strong signal suppressor for the purpose of synthesizing, from the I/F signals produced by said reference GPS sensors, an I/F signal specific to said hemispherically visible GPS satellite, with one or more of the strongest potentially-interfering GPS satellite signals suppressed, for input to a satellite acquisition system.

9. A GPS assistance system, for providing accurate satellite-specific frequency and phase as well as PRN code phase information and decoded 50 Hz data to GPS receivers in the vicinity of said GPS assistance system, is presented, comprising:
strong signal attenuation means for generating one or more GPS satellite-specific I/F signals, enabling more efficient and effective acquisition of the one or more designated satellites;
correlation means for the purpose of deriving, from the one or more GPS satellite-specific I/F signals generated by said strong signal attenuation means, accurate satellite-specific frequency and phase as well as PRN code phase information and decoded 50 Hz data for use by target GPS receivers in the vicinity of said strong signal attenuation means; and
control means for controlling the strong signal attenuation means.

10. The GPS assistance system of claim 9, wherein the strong signal attenuation means is comprised of:
multiple reference GPS sensors, some or all with uni-directional antennae and front ends for down converting composite GPS satellite signals into GPS satellite-specific I/F signals, and
multiplexing means for selecting one or more of the GPS satellite-specific I/F signals produced by said reference GPS sensors, for input to said correlation means.

11. The GPS assistance system of claim 10, wherein the multiplexing means, directed by the control means, selects one or more GPS satellite-specific I/F signals corresponding to a set of one or more GPS satellites designated for acquisition.

12. The GPS assistance system of claim 11, wherein the set of satellites designated for acquisition is the set of satellites hemispherically visible over said strong signal attenuation system.

13. The GPS assistance system of claim 11, wherein the set of satellites designated for acquisition is the set of satellites electronically visible to a target GPS receiver in the vicinity of said strong signal attenuation system.
